(19) United States
(12) Patent Application Publication
(10) Pub. No.: US 2002/0029205 A1
(43) Pub. Date: Mar. 7, 2002

(54) Industry and/or other specific educatable/reasoning artificial intelligence analyzation control system(s), process(es)and/or method(s) to increase accuracy, reduce human error faults in new or existent system(s), process(es) and/or method(s)

(76) Inventors: Alfonso Pedraza, Miami, FL (US); Scot Guider Caviness, Coleman, FL (US)

Correspondence Address: SHAHNDA CAVINESS, 700 LAKE ORCHID CIRCLE, M101, VERO BEACH, FL, 32962, US

(21) Appl. No.: 09/841,982

(22) Filed: Apr. 25, 2001

Related U.S. Application Data
(60) Provisional application No. 60/199,906, filed on Apr. 26, 2000.

(51) Int. Cl. G06F 15/18

(52) U.S. Cl. 706/21

(57) ABSTRACT

This invention relates to the application and optimization of algorithms which enable advanced pattern matching such as contextual recognition processing. These algorithms derive the meaning of, or contextualize, a body of information, enable more accurate speech recognition, have the ability to process data in a self-educating fashion, etc. (see reference 1 and 2). These abilities will be utilized by this invention in a multilayered processing system which has the ability to self-educate and perform simple and/or complex industry and other specific processing tasks. By automating these processing tasks, this invention increases efficiency and reduces the possibility of human error faults by reducing the degree of required human interpolation.

### CROSS-REFERENCE TO RELATED APPLICATIONS

This application is related to provisional application, Ser. No. 60/199906, filed Apr. 26, 2000, filed pursuant to 35 USC 11(b) and Rules 51 and 53, the benefit of which filing date is claimed.

### BACKGROUND OF THE INVENTION

The present invention relates to artificial intelligence hereinafter written (a.i.), application control system(s), process(es) and/or method(s), or any combination thereof for utilizing A.i. device(s) applied to industry or other specific or nonspecific data to first educate the A.i. device(s) then to utilize this/these educated, free-thinking/reasoning device(s) to analyze problem(s), case(s), situation(s), or to provide any combination of the above analyzed/processed or non-processed information as desired. Control system(s), process(es) and/or method(s), or any combination thereof to be implemented in all fields or situations not similarly claimed in prior art.

The concept of applying past knowledge to solve current problem(s), case(s), issue(s) or to provide information desired is and has been standard common practice in most mental processing and is integral to the operation(s) of many industries as well as other situations throughout history. The advent of computers greatly simplified many processing needs. Yet even today's most fully automated processes can be subject to much human interaction such as designating data to be processed, the steps involved in processing actions, and interpretation of the results of processed data. As such, there exists the potential for human error faults in many of today's state of the art automated systems and methods for processing data.

The inventors see this potential for human error fault as a serious liability, especially where complex processing depends upon various levels of human interaction, such as the designation of data, processing procedures, and the interpretation of processed data. In their quest to solve this problem, the inventors discovered an article in the February, 2000 issue of Wired Magazine titled “Quest for Meaning” which focused on the mathematical musings of 18^{th} Century Presbyterian minister Thomas Bayes.

Bayes theorem, when utilized in a processor application, acts as a “reasoning engine” that “empowers computers to act . . . (as a) human by comprehending context, generalizing words from an idea, and even understanding the unspoken by grasping the root concepts beneath the syntax”.

This article also delved into Michael Lynch, the one who discovered Bayes' theorem and his envisioned applications of the algorithm. These applications focus on basic pattern recognition, speech recognition and audio signal filtering processes.

Upon reviewing Michael Lynch's company's white paper, the inventors discovered that the level of human interaction required to operate his systems would still result in what the inventors believe is an unacceptably high possibility of human operator, programmer, and/or interpreter error faults.

Believing they had new use applications for artificial intelligence type processing they conducted an extensive patent search. Of all the patents claiming an artificial intelligence process or method, none describe free thinking, reasoning artificial intelligence algorithm utilizing outcome producing systems.

For example, one patent, U.S. Pat. No. 5,875,431, possesses the scope to encompass a nearly autonomous operating system. However, U.S. Pat. No. 5,875,431 claims a provision of at least one “best practices base line template” to be utilized in a comparative analyses type system.

In addition, as with all patents reviewed, U.S. Pat. No. 5,875,431 requires in-depth, human operator, programmer and interpreter interaction and, thus, U.S. Pat. No. 5,875,431 is still subject to what the inventors believe is an unacceptably high probability of human error faults.

### BRIEF SUMMARY OF THE INVENTION

The Object

It is the object of this invention to provide a system of processes composing a method of fully and/or almost fully autonomous complex single and/or multi-dimensional data processing perations.

By applying the recently developed and/or other artificial intelligence algorithms in various combinations and processing sequences, data can be automatically selected, processed or educated, reprocessed or reeducated and/or further manipulated in a vast array of processing sequences. In addition, an outcome or plurality of outcomes can be automatically presented in accordance with required and/or a.i. type processor determined criteria.

The Advantage

The advantage claimed by this invention is a process of applying newly developed artificial intelligence algorithms to produce a more autonomous processing system and/or plurality of systems. The result of these systems is a more human error fault free system of processes which will, at the least, directly reduce the cost incurred from having to reprocess processor data.

### BRIEF DESCRIPTION OF THE SEVERAL VIEWS OF THE DRAWING

FIG. 1 shows a step by step flow chart relating to the first independent claims's method for utilizing the referenced and/or other artificial intelligence algorithms.

FIG. 2 shows a step by step flow chart relating to the second independent claims's system for utilizing at least one artificial intelligence algorithm.

FIGS. 3 through 8 relate to the third independent claim; and the

### DETAILED DESCRIPTION OF THE INVENTION

Overview

The invention comprises a new system of methods and processes possessing the capability to employ the referenced and/or other artificial intelligence algorithm processes—hereafter designated a.i.a.p.—such as those detailed in the referenced Autonomy™ white paper. Said artificial intelligence algorithms—hereafter designated a.i.a.—are to be utilized in various combinations and processing sequences to create a fully or near fully autonomous outcome result and/or to provide other information as desired.

The complexity of said various combinations and processing sequences—hereafter defined simply as process sequencing—of the employed a.i.a.p. can vary from a single basic fully or near fully autonomous a.i.a.p. enabled outcome producing system to as advanced as a multidimensional, processing intensive outcome producing system of processes. Accordingly, the system's special hardware requirements may vary from a conventional type computer's equipment and capabilities to as advanced as a shared information multiple layered, neural networking system.

This flexibility allows the a.i.a.p. to be tailored to specific applications where said invention can increase economy and reduce the degree of required human interpolation. In so doing, the a.i.a.p. system will reduce the possibility that human error faults will occur.

### BEST MODE FOR CARRYING OUT THE INVENTION

The following description is an example of one possible embodiment of the invention and does not represent limitations regarding claims or other possible variations of this invention or the embodiment detailed. In addition, this description will clearly enable one skilled in the arts to make and use this invention.

This embodiment of the invention entails a new method, comprising a system of processes which will reduce the degree of human interpolation required in the federal judicial system. By automating virtually every facet of the federal judicial field and its processes, this embodiment of the invention will greatly reduce the inherent and presently accepted human error faults which tax our judicial resources, such as those involved in having the correct these faults through litigation intensive redress.

Referring now to figure ______, the computer based artificial intelligence enabled judicial processing system embodiment of the invention is shown in a block diagram chart configuration comprising:

A) Artificial Intelligence Enabled Processor System

This processor possesses the capabilities of the referenced Autonomy™ or similar products configured to function as defined in the claims of this patent. And, installed in the a.i. enabled processor system (A), in a manner consistent with the claims of this patent and the referenced Autonomy™ or similar products's capabilities, is a primary application data set comprised of:

B) The United States Code Annotated

The United States Code encompasses all federal statutes, (See attachment ______, index of the U.S.C.A.), and includes:

B-1. The Federal Rules of Civil Procedure

These govern the procedural requirements to be followed in civil matters.

B-2. The Federal Rules of Criminal Procedure

These govern the procedural requirements to be followed in criminal matters (this includes the Federal Sentencing Guidelines).

B-3. The Federal Rules of Appellate Procedure

These govern the procedural requirements to be followed in appellate proceedings.

B-4. The Federal Rules of Evidence

These govern the procedures for admitting and concerning evidentiary matters.

The United States Code, in particular B-1 through B-4 above, provides a well defined, codified outline of the United States Federal Judicial procedural processes and, as such, this data will serve as the primary process defining system for this embodiment of the invention.

Federal Case Law And Other Interdependent Data Sets

Presently integral to the codified system of federal statutes is the use of prior case authority to define, clarify, modify, validate, and supersede existing legal theories that are based on the interpretation of these statutes. In addition, these past case data sources, referred to as legal authority, often set new standards of practice and add to the hypothesis that the U.S. judicial processes are living systems of justice.

Federal Case Law is divided into

C-1, 2. Published Opinion

Both Supreme Court (C-1) and Circuit Court (C-2) case law are relied upon and widely accepted when presenting an issue.

C-3. Unpublished Opinion

This is by and large considered unofficial. However, this information should still be considered because unpublished case law may highlight an up-and-coming legal trend or a method of redress for issues previously not successfully explored.

C-4. Other Data

This category includes treatises such as published articles and opinions which refer to or concern case law and/or which help to more clearly define a relevant legal statute or issue.

Data sets C-1 through C-4 above will be made available and utilized by this embodiment of the invention as defined by the claims of the invention and the referenced Autonomy™ product's capabilities. These data sets will act as data base subsystems and will support the primary a.i. enabled application comprising the United States Code and will have contextual links and contextual hyperlinks with the primary application and other systems and/or susbsystems of the invention.

D.) Peripheral Data Sets

Consistent with presently accepted legal practices, the artificial intelligence enabled federal judicial processing system can access and make use of a myriad of peripheral data sources. Peripheral data is defined as all information not previously detailed herein which the embodiment of this patent could utilize the produce a most accurate and human error fault free finding. Examples of these data sources include, but are not limited to:

D-1 Internet Accessible Data

This data includes reference source sites which provide technical data, industry and company specific data, etc.

D-2. Public Records

These records refer to all official public record data made available under the freedom of information act and include personnel records, litigation data such as criminal and civil case records, official statistical data, etc.

D-3. N.C.I.C.

The National Criminal Information Center is a data center which provides detailed information on known and suspected criminals and their nefarious activities.

D-4. Other Peripheral Data

This data includes articles published in newspapers, magazines, trade publications, etc.

USE OF SYSTEM

The detailed embodiment, constructed and enabled as per the claims and descriptions of this patent and the Autonomy™ product's capabilities, will be produced to function imbedded in the disk operation system or systems of portable laptop like or other computing devices.

These systems will be either leased or sold to qualified system operators such as judiciary members, A.B.A. certified attorneys, certified paralegals, legal secretaries, etc.

1). When buying or leasing the system device, the system operators will establish account(s) with the system access/service provider(s).

2) These account(s) can then be accessed by the system operator(s) via the device(s) and an Internet type interface means whereby a use or a number of uses can be authorized as ordered.

A use may be defined as any processing need for one case or issue in a pretrial/prehearing through said trial or hearing phase. A separate use may entail post-trial or post-hearing processing needs. These phases are clearly defined and will be controlled by the a.i. enabled disk operating systems and the a.i. enabled, United States Code based, primary applications. In addition, other use schedules may be provided which will enable system users to conduct research and other needed operations in an autonomous or near autonomous fashion.

Furthermore, a use could relate to any aspect of the federal judicial processes and may entail interaction with similarly enabled local, international, foreign, or maritime artificial intelligence enabled judicial service provider systems and/or related or unrelated data base systems.

3). Once access is authorized, a series of a.i. enabled prompts will query the system operator to enter pertinent data relevant to the authorized use. These prompts may request the query response be entered utilizing various means such as:

A. Keyboarded input of data such as records.

B. Scanned input of data such as civil or criminal complaints, indictments, lab reports, trial and other transcripts, etc.

C. Video and audio input of data such as depositions, trial and other hearings, and other case or issue-specific information.

4). When a query response has been entered into the system device as directed, the system will then contextualize the data as per the claims of this patent and the referenced Autonomy™ or similar product's capabilities. This processing is similar to the processing required when initially educating the system.

5). As the data is contextualized, the system utilizes its a.i. enabled processors and other capabilities to compare the case specific issues against the contextualized primary Application Data (Fig. ______ , the Case Law Data (Fig. ______ ), and Other Peripheral Data (Fig. ______ ). In so doing the issues will be repetitively defined and as the case or issue develops the system will constantly provide on point results.

6). The result of this processing can assist an attorney or others during a hearing or trail by providing instantaneous or near instantaneous recommendations, directions, reactions to other positions, relevant case law and other pertinent data.

7.). The results of this processing can also be utilized by this embodiment of the invention to produce in a near autonomous fashion motions, pleadings, requests, queries, etc.

8). In addition, the results of these processes may be utilized to update the federal judicial processor's and similar systems' education.

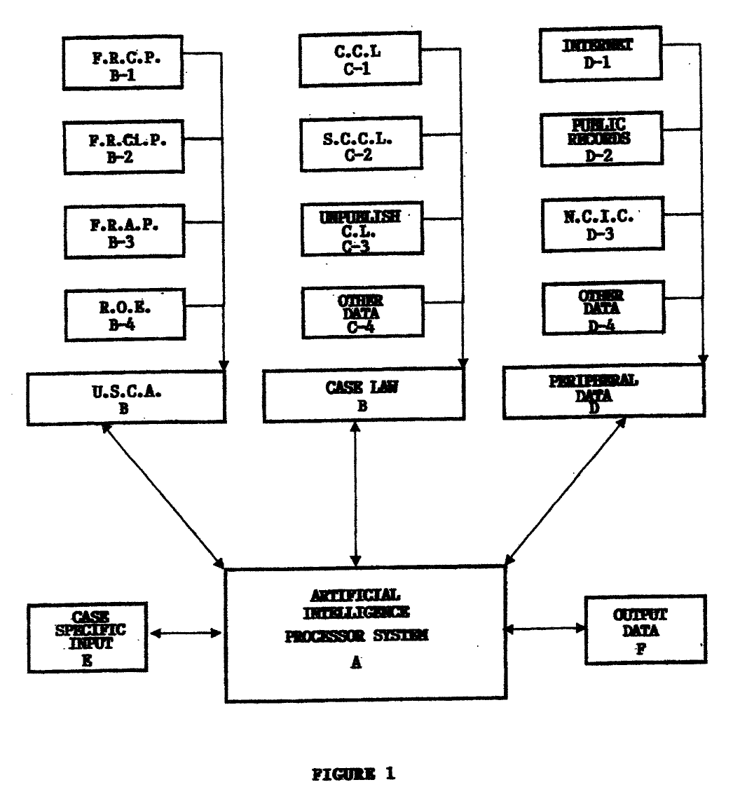

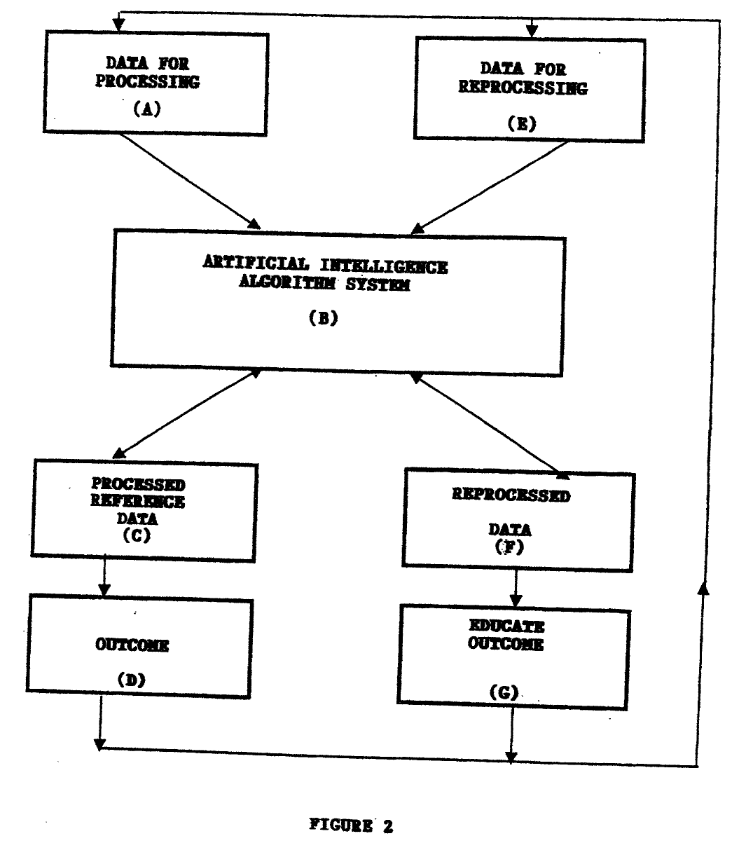

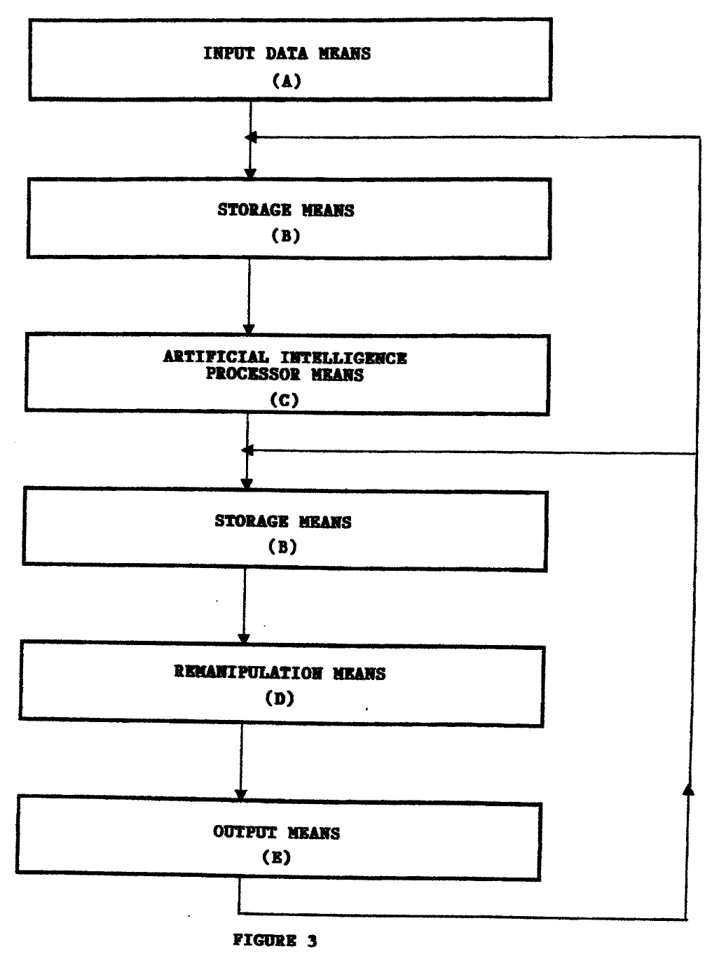

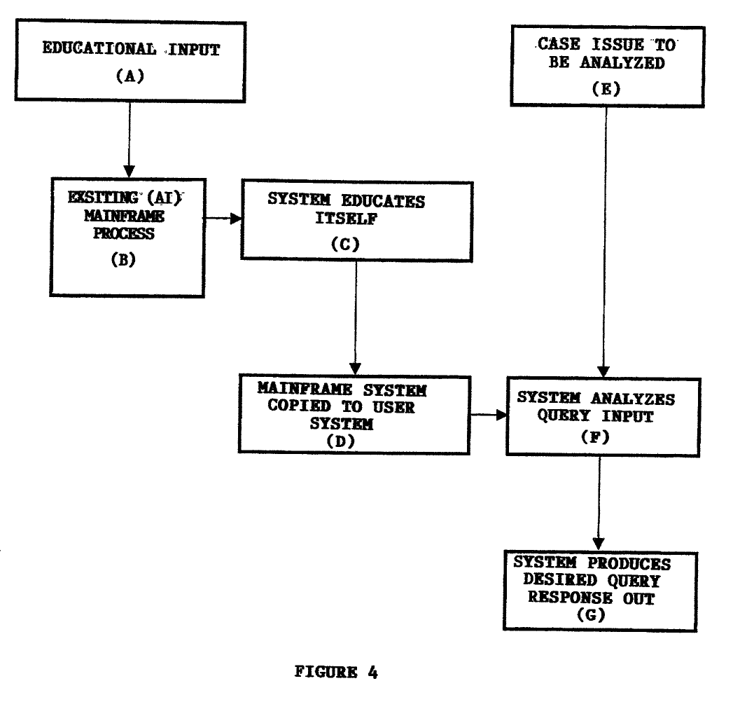

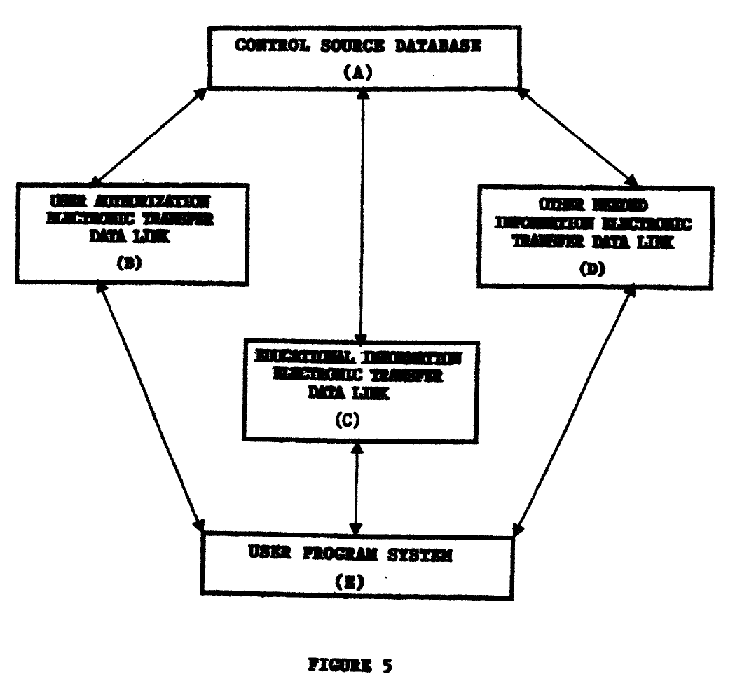

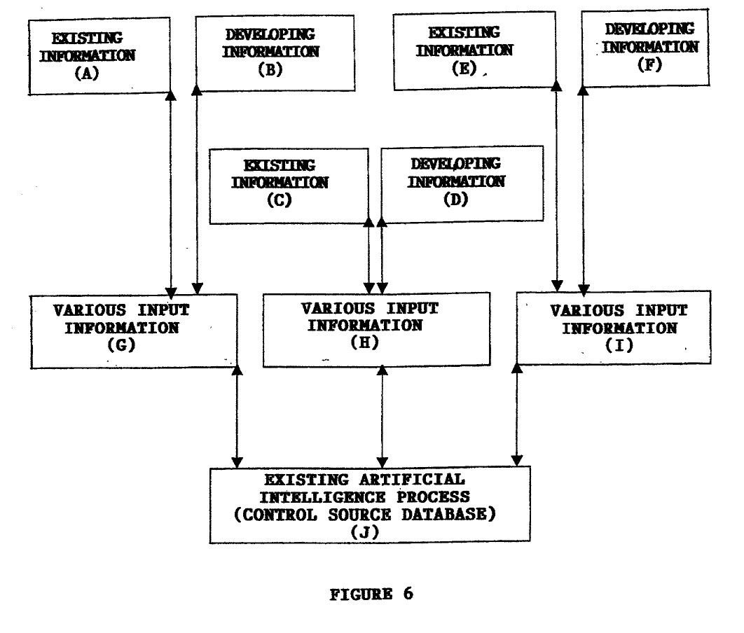

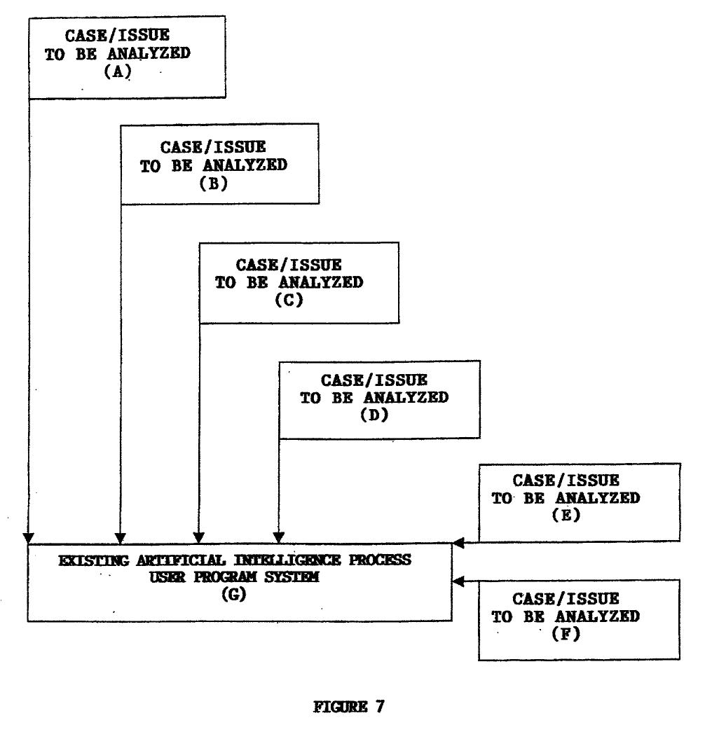

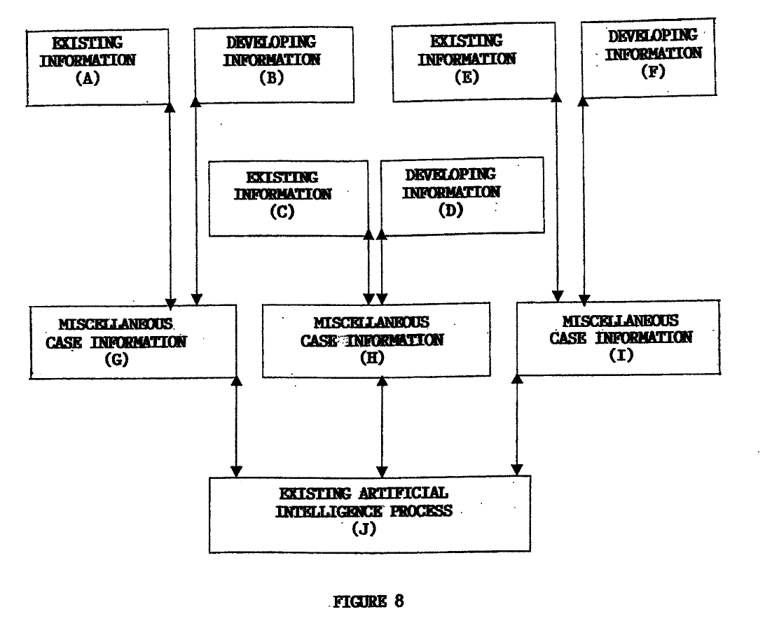

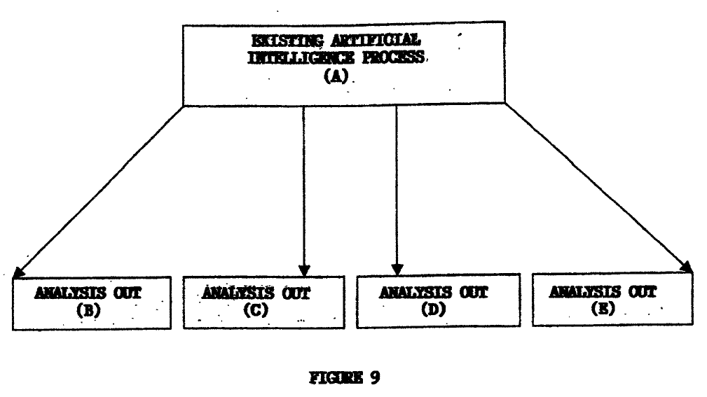

1. A method (FIG. 1) utilizing the referenced and/or other artificial intelligence algorithms and their capabilities to produce a human error fault free outcome and/or other information producing system or new processes comprising in operative combination the steps of:
A). Processing at least one piece of data, data set, and/or other information (a) utilizing said referenced and/or other artificial intelligence algorithms, (b) said processed at least 1 piece of data, data set, and/or other information to be utilized as reference data, (c) and/or as an outcome and/or used to produce other information (d) as desired, and
B.) Processing at least one time at least one piece of data or data set and/or other information (e) utilizing at least one artificial intelligence type algorithm, (b) and said processed reference data (c) and/or other information (f) to produce a further artificial intelligence algorithm processed or educated outcome (g).
C). Utilizing said artificial intelligence algorithm system (b) to employ outcome (d) or (g) as input data (a) and/or (e) and/or as reference data to further process and define processed and/or unprocessed data.
Whereby the combination of unprocessed and/or processed data and the repetitions or combinations of the processing procedures produces outcome results varying in complexity from autonomous or nearly autonomous pattern matching as detailed in the referenced Autonomy™ white paper to as advanced as fully autonomous multiple data processing, task intensive, repetitive processing method.
Whereby a person can educate the invention and/or allow the invention to self-educate itself and then data for processing can be autonomously processed and a human error fault reduced or fault free outcome can be produced.

2. A free thinking reasoning artificial intelligence algorithm based outcome producing system (FIG. 2) comprising in operative combination the means to utilize the referenced and/or other artificial intelligence algorithms and/or through other means to automatically or in a near automatic mode:
A). Input utilizing at least one input means such as a data transfer bus, modem, compact, or digital video disk, etc. at least one piece of unprocessed or uneducated and/or at least one piece of processed or educated data in operative combination,
B). Store utilizing at least one storage means such as a random access memory, read only memory, hard drive, disk, outsourced storage and/or system service provider, etc. any data in operative combination,
C). Manipulate utilizing at least one manipulation/processing means such as an artificial intelligence algorithm enabled and educated micro-processor, co-processor, sub-processor, math co-processor, neural network, etc. to process the input data and/or other data in operative combination,
D). Remanipulate data utilizing at least one remanipulation means such as those described in the manipulation/processing means (c) above to reprocess data utilizing other self-educated or other unprocessed, uneducated and/or processed educated or any combination of data as reference data and/or to aid in the analysis of similar and/or dissimilar data in operative combination,
E). Output data utilizing at least one output means such as a data bus, modem, printer compact and/or video disk, outsource service provider, etc. to possible self-select output means and output processes and/or other data in operative combination,
F). The means to automatically or otherwise input, manipulate, store, transfer, process, and reprocess said at least one outcome as entailed in dependent claims A through E or in any operative combination.
Whereby the combination and/or repetition of prior art processes results in a new and novel outcome producing system which derives at least one outcome in a fully or near fully autonomous process.
Whereby the outcome producing system is useful because the possibility of human operator/interpreter error is minimized.

3. A free-thinking, reasoning artificial intelligence algorithm or plurality of algorithms utilizing outcome and/or other information producing system having the capabilities to autonomously or in a near autonomous fashion input, store, process, reprocess, transfer, and output unprocessed uneducated and/or processed, educated data in operative combinations as needed and having the means to autonomously or in a near autonomous fashion control and,
A). Authorize access to said outcome producing system's capabilities for other similarly structured outcome producing and/or conventional computer system to interact in operative combination with and/or to,
B). Authorize user access to said similarly structured outcome producing and/or conventional computer system's said free-thinking, reasoning, artificial intelligence algorithm or plurality of algorithms utilizing outcome producing capabilities.
Whereby the outcome producing system described herein has at least one means to autonomously or in a near autonomous fashion control a user's access to a user's outcome producing system and/or control access to a user system possessing the capabilities of the outcome producing system in operative fashion.
Whereby the outcome producing system comprises a new, novel and useful invention, having the capabilities of reducing human error faults in existing or future non, semi and/or fully automated processes.
